(19) United States
(12) Patent Application Publication
(10) Pub. No.: US 2016/0230728 A1
(43) Pub. Date: Aug. 11, 2016

(54) Plunger And Fluid-Line System

(71) Applicant: CONTINENTAL AUTOMOTIVE GMBH, Hannover (DE)

(72) Inventors: Willibald Schuerz, Pielenhofen (DE); Roman Etlender, Ingolstadt (DE); Werner Reim, Regensburg (DE)

(73) Assignee: Continental Automotive GmbH, Hannover (DE)

(21) Appl. No.: 15/028,425

(22) PCT Filed: Sep. 29, 2014
(86) PCT No.: PCT/EP2014/070829

§ 371 Date: Apr. 9, 2016

(30) Foreign Application Priority Data
Oct. 11, 2013 (DE) 10 2013 220 547.3

(51) Int. Cl. F02M 61/10; F02M 63/02; F02M 51/06

(52) U.S. Cl. CPC F02M 61/10; F02M 51/061; F02M 63/0225; F02M 51/0603

(57) ABSTRACT

The present disclosure relates to a fuel injector comprising a piston and a fluid line. The geometry of the piston and/or a geometry of the fluid line are/is configured such that the piston is positioned eccentrically in the fluid line by the fluid.

### CROSS-REFERENCE TO RELATED APPLICATIONS

This application is a U.S. National Stage application of International Application No. PCT/EP2014/070829 filed Sep. 29, 2014, which designates the United States of America, and claims priority to DE Application No. 10 2013 220 547.3 filed Oct. 11, 2013, the contents of which are hereby incorporated by reference in their entirety.

### TECHNICAL FIELD

The present disclosure generally relates to control-plunger/control-bore arrangements and, more specifically, to a control piston-control bore arrangement for an injector which may be used as a fuel injector for a direct injection system of a motor vehicle.

### BACKGROUND

Ever more stringent legal regulations with regard to admissible pollutant emissions of internal combustion engines for motor vehicles necessitate the use of fuel injectors to achieve improved mixture preparation in the cylinders of the internal combustion engines. In the case of such injectors, control of an injection of fuel is performed by way of a nozzle needle which is mounted displaceably in the injector and which, in a manner dependent on the stroke thereof, opens up and closes off again an opening cross section or one spray hole or a multiplicity of spray holes of a nozzle assembly of the injector. An actuation of the nozzle needle is performed for example by way of a piezoelectric actuator, which actuates the nozzle needle hydraulically or mechanically.

To reduce the pollutant emissions of the internal combustion engine and at the same time keep the fuel consumption thereof as low as possible, it is desirable to achieve optimized combustion within the cylinders of the internal combustion engine. For good process implementation and/or control/regulation of a combustion in the cylinders, it is necessary for the fuel to be injected to be able to be dosed in as exact a manner as possible in terms of volume and time in order, at all times, to achieve optimized combustion and/or the most complete possible regeneration of a particle filter of the motor vehicle, because torque demands of the internal combustion engine are converted into injection quantities, which in turn correlate with an injection duration in a manner dependent on an injection pressure, a stroke of the nozzle needle and a geometry of the injector.

A deviation of an actual injection quantity—a so-called shot—from a setpoint injection quantity of the injector always has an adverse effect on a combustion, that is to say on the pollutant emissions generated thereby, and normally also on fuel consumption of the internal combustion engine. For directly injecting injectors, high demands exist with regard to accuracy of the injection quantities and a stability of a jet pattern under all operating conditions and over an entire service life of the injector. This applies in particular with regard to small injection quantities in a multiple-injection mode with the associated short injection intervals, and/or in a partial lift mode of a nozzle needle.

In a modern injector, to ensure the least possible shot-to-shot variance, it is necessary for a fluid pressure in a control chamber of the injector to be maintained as exactly as possible, in a manner dependent on a rail pressure, during an injection interval. Said pressure is set in a manner dependent on flow resistances in the individual leakage paths (inflowing and outflowing) of the injector. Since a flow resistance of a control piston (piston) of the injector, which is paired with a control bore (fluid line) with a defined fit, is dependent on a positioning of the piston (centrally, eccentrically, tilted) in the control bore, this yields an influence on a control chamber pressure that is set, and thus on an injection quantity. Stochastic fluctuations of said pressure owing to fluctuating positioning of the control piston in the control bore lead to increased stochastic fluctuations of the injection quantities, that is to say to increased shot-to-shot variance.

### SUMMARY

The present disclosure relates to systems for a fluid pressure in a fluid chamber to be reproducibly set by way of a piston in a fluid line, wherein it should be possible for a position of the piston in the fluid line to be set in a reproducible manner. In particular, a fluid pressure in a control chamber of an injector, in particular of a fuel injector, may be set or maintained as exactly as possible, in a manner dependent on a rail pressure, during an injection interval. It is thereby intended to improve, for example, shot-to-shot variance, in particular for a hydraulically directly driven injector.

In some embodiments of the present teaching, the piston-fluid line arrangement comprises a piston, which is fitted in or paired with a fluid line and which can be positioned sideward hydraulically by way of a fluid passing through the fluid line, wherein a geometry of the piston and/or a geometry of the fluid line are/is configured such that the piston can be positioned, and/or is positioned, eccentrically in the fluid line by the fluid. The geometry of the piston may be a secondary geometry, wherein a primary geometry of the piston may be cylindrical. Likewise, the geometry of the fluid line may be a secondary geometry, wherein a primary geometry of the fluid line likewise may be cylindrical. The injector may have a piston-fluid line arrangement, in particular a control piston-control bore arrangement.

In some embodiments, the secondary geometry of the piston and/or the secondary geometry of the fluid line are/is configured such that a centerline of the piston can be positioned, and/or is positioned, substantially parallel to a centerline of the fluid line by the fluid. Furthermore, the geometry/geometries may be selected such that a throughflow of the fluid between the piston and the fluid line (sealing gap) is greater than a throughflow in the case of a concentric position of the piston in the fluid line. In this case, it is possible for the throughflow of the fluid between the piston and the fluid line to be set as a substantially maximum throughflow. Here, the piston assumes a substantially intensely eccentric position in relation to the fluid line. Such an embodiment may be advantageous in some applications, wherein a greatest minimum throughflow is set in the case of a given fit or pairing of the piston and the fluid line.

In some embodiments, the secondary geometry of the piston and/or the secondary geometry of the fluid line are/is configured such that an asymmetrical pressure distribution of the fluid can be set, and/or is set, in a sealing gap between a shell face of the piston and an internal face of the fluid line. Furthermore, the geometry/geometries may be selected such that, in the shell face of the piston and/or the internal face of the fluid line, there is provided a fluid path by way of which the asymmetrical pressure distribution of the fluid in the sealing gap can be set and/or is set.

Furthermore, the geometry/geometries may be selected such that, in the shell face of the piston and/or the internal face of the fluid line, the fluid path is provided such that a sideward force can be exerted, and/or is exerted, on the piston by way of the fluid. The asymmetrical pressure distribution of the fluid in the sealing gap gives rise to the sideward force of the fluid on the piston, wherein the sideward force is intended to act on the piston, that is to say the asymmetrical pressure distribution on the piston is intended to be set, such that the centerline of the piston is oriented parallel to, and shifted in a parallel manner with respect to, the centerline of the fluid line.

In some embodiments, the fluid path may be formed such that the piston is permanently securely positioned in an eccentric position during relevant operating states and, in this case, the throughflow of the fluid through the sealing gap is relatively low. In the case of a given pressure difference at the piston, a target throughflow of fluid through the sealing gap may be primarily as constant as possible and secondarily as small as possible. A relatively large eccentricity of the piston also entails a relatively large throughflow of fluid through the sealing gap, and it is therefore preferable to seek a reliable eccentric position in which the throughflow of the fluid through the sealing gap that is generated is relatively low. That is to say, a relatively slight eccentric position, which is however geometrically constant over time, of the piston in the fluid line.

In some embodiments, the fluid path may be provided on/in the piston and/or on/in the fluid line. The explanations below relate primarily to the piston and are also transferable, where it appears to be expedient, to the fluid line. It is accordingly possible for the fluid path on/in the piston to be configured such that it can be placed in fluidic communication with a high-pressure side or with a low-pressure side of the piston. Here, the fluid in the fluid path forces the piston away from an opening of the fluid path on/in the piston, and/or the fluid in the sealing gap forces the piston toward an opening of the fluid path on/in the piston. The low-pressure side is to be understood to mean a face region of the piston, in which a fluid pressure prevails which is lower than that at the high-pressure side of the piston. Said pressure difference may be even only a few bar, wherein it is by all means possible for a fluid high pressure to prevail on the low-pressure side.

That is to say, for the former case, the fluidic connection of the fluid path to the high-pressure side of the piston, the fluid in the fluid path forces the piston away from the opening of the fluid path in the direction of a region, situated radially opposite said fluid path, of the internal face of the fluid line. Also, for the second case, that is to say the fluidic connection of the fluid path to the low-pressure side of the piston, the fluid in the sealing gap forces the piston in the direction of the opening of the fluid path at a region, situated directly opposite the opening, of the internal face of the fluid line.

In some embodiments, the fluid path may have a recess on/in the piston, wherein the recess is in particular a groove or facet which runs, in sections, in a circumferential direction and/or, in sections, in a longitudinal direction of the piston. A base of the recess may be planar or curved, that is to say the base of the recess has, for example, a radius. Such embodiments are relatively easily transferable to the fluid line. Furthermore, the fluid path may have a fluidic connection of an interior and an exterior of the piston, wherein the fluidic connection is in particular a bore, preferably a passage bore and/or an intersection, preferably of an internal and external recess of the piston.

In some embodiments, the fluid path on the outside of the piston may have the opening, a circumferential groove, a circumferential facet, a longitudinal groove and/or a longitudinal facet. Furthermore, the fluid path may comprise at least one bore from an outer side of the piston to a piston interior. Furthermore, the fluid path may have an intersection of an external recess with an internal recess and/or a cutaway portion on a longitudinal end section of the piston. According to the invention, the piston may be in the form of a control piston, a pin, a control pin or a leakage pin. In the case of a fuel being used, the fluid is preferably a diesel or gasoline fuel.

In some embodiments, it is possible for a fluid pressure in a fluid chamber to be set by way of a reproducible piston position in a fluid line. Here, a position of the piston in the fluid line is set by way of a geometry of the piston and/or of the fluid line. Here, the invention is particularly suitable for use on injectors, in particular fuel injectors, wherein, during an injection interval, a fluid pressure in a control chamber of the injector can be set or maintained in an effective manner. That is to say, the shot-to-shot variance of the injector is improved. Furthermore, a variance with regard to an injector function in a mass production context is reduced, and a fraction of injectors which do not conform to demanded tolerances in terms of their injection quantities can be reduced. It is thus also possible for outlay with regard to required reworking to be reduced. This results, individually and overall, in a reduction in production costs.

### BRIEF DESCRIPTION OF THE DRAWINGS

The invention will be discussed in more detail below on the basis of exemplary embodiments with reference to the appended drawing. Elements or components which have an identical, univocal or analogous form and/or function are denoted by the same reference designations in different figures of the drawing.

In the schematic figures of the drawing,

FIG. 1 shows a longitudinal side view of an injector according to the invention for a common-rail injection system of an internal combustion engine, said injector being illustrated in centrally sectioned form in the middle and at the bottom;

FIG. 2 shows a centrally sectioned, detailed longitudinal side view, cut away at the top and bottom, of a control assembly of the injector from FIG. 1, with a hydraulic direct drive of a nozzle needle; and

FIGS. 3 to 5 show a first embodiment,

FIGS. 6 to 8 show a second embodiment,

FIGS. 9 to 11 show a third embodiment,

FIGS. 12 to 14 show a fourth embodiment,

FIGS. 15 to 17 show a fifth embodiment,

FIGS. 18 to 20 show a sixth embodiment, and

FIGS. 21 to 23 show a seventh embodiment, of a piston-fluid line arrangement according to the teachings of the present disclosure, in particular of a control piston-control bore arrangement.

Here, a respectively first figure of the embodiments is a sectional side view, and a respectively second figure is a sectional plan view of a control plate of the injector. The respectively third figure of the embodiments is in this case a perspective view of a control piston of the injector. Furthermore, FIGS. 24 and 25 show two embodiments of the use of the invention on a fluid line.

### DETAILED DESCRIPTION

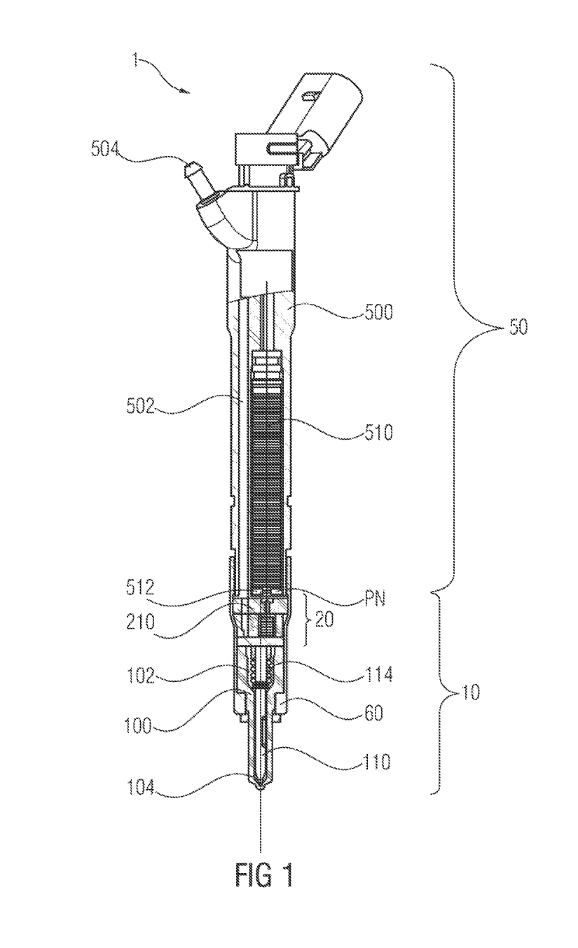

The invention will hereinafter be discussed in more detail on the basis of a piezoelectrically operated common-rail diesel injector 1 for an internal combustion engine (see FIG. 1). The teachings of the present disclosure are not limited to use with such diesel injectors 1, but may for example also be applied to pump-nozzle injectors or gasoline injectors with a unipartite or multi-part nozzle needle. For gasoline injectors, typical designations can be found in the list of reference numerals. An injectable fluid may be a fuel, though it is self-evidently possible for an injector 1 according to the invention to be used for the injection of some other fluid, such as for example water, an oil or any other desired process fluid; that is to say, the injector 1 is not restricted to the automobile industry.

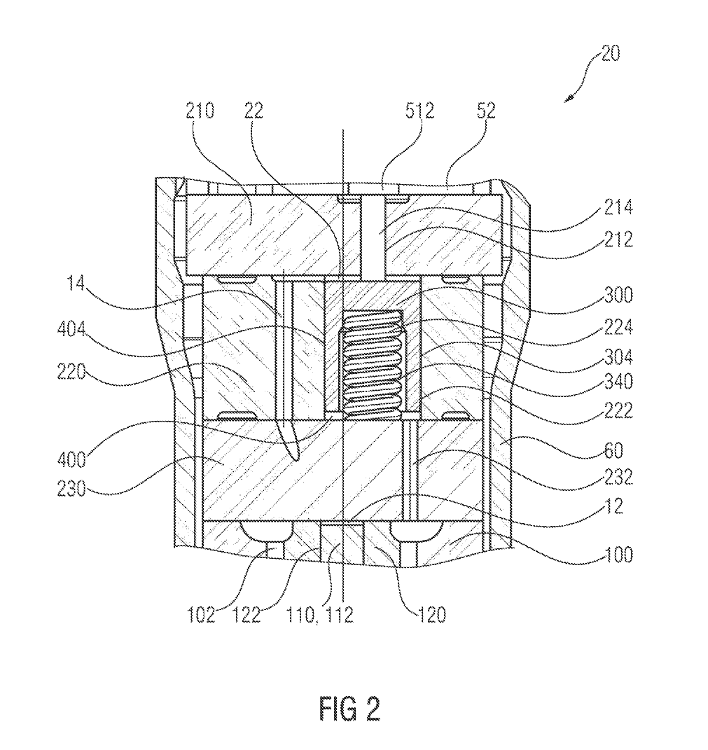

FIG. 1 shows the injector 1 substantially in a sectional view, wherein the injector 1 comprises a nozzle assembly 10 and an injector assembly 50. The nozzle assembly 10 and the injector assembly 50 are fixed to one another in fluid-tight fashion by way of a nozzle clamping nut 60. The injector assembly 50 has an injector body 500 in which an actuator 510, which is preferably in the form of a piezo actuator 510, is provided. Use may however also be made of an electromagnetic actuator. In the present example, the piezo actuator 510 hydraulically directly drives a unipartite, preferably integral, nozzle needle 110 (see also FIG. 2). The nozzle needle 110 may also be of two-part or multi-part form, and/or be designed to open outwardly in the injector 1.

The injector body 500 has a high-pressure-side fluid port (not illustrated) for the fuel to be injected, wherein the fluid port is in fluidic communication with a high-pressure bore 502 formed in the injector body 500. By way of the high-pressure-side fluid port, the injector 1 can be hydraulically connected to a high-pressure fluid circuit (not illustrated). The high-pressure bore 502 supplies fuel at high pressure, for example a so-called rail pressure (common-rail system), to the nozzle assembly 10 and thus to a nozzle chamber 102 of the injector 1. During the operation of the injector 1, an actually high or maximum pressure substantially always prevails in the nozzle chamber 102.

The nozzle assembly 10 has a nozzle body 100 with at least one spray hole (not illustrated) in its nozzle 104 and the nozzle chamber 102, wherein the nozzle needle 110 is arranged displaceably, and mounted in sections, in the nozzle chamber 102. The nozzle needle 110 is forced in the direction of its nozzle needle seat at the inside in the nozzle 104 by way of an energy store 114, preferably a nozzle needle spring 114, so as to be reliably closed even in an electrically deenergized state of the piezo actuator 510. In a manner dependent on an actuation of the piezo actuator 510, the nozzle needle 110 is either forced into its nozzle needle seat or moved away from the nozzle needle seat, whereby fuel can be injected.

The nozzle assembly 10 furthermore accommodates a control assembly 20, which is situated between the nozzle body 100 and the injector assembly 50, for the control of the nozzle needle 110 on the basis of a lengthening of the piezo actuator 510 in a manner dependent on the energy or charge of said piezo actuator, that is to say in a manner dependent on an electrical voltage applied to said piezo actuator. FIG. 2 shows the components of the control assembly 20 for a direct hydraulic coupling by way of a lengthening movement of the piezo actuator 510 and a resulting movement of the nozzle needle 110. The piezo actuator 510 has, for this purpose, a base plate 512 with a preferably integral actuating projection which is in direct mechanical contact with a transmission pin 214 which is, with a very small clearance, fitted in and/or paired with a pin bore 212 of an intermediate plate 210 of the control assembly 20.

A pairing clearance of the transmission pin 214 in the pin bore 212 is selected to be so small, for example approximately 1 μm, that, even in the presence of a high rail pressure of up to over 2500 bar, only a small amount of fuel leakage occurs at the transmission pin 214. Here, the pin bore 212 connects a first control chamber 22, which is also referred to as piston control chamber 22 and in which a fuel pressure prevails which is slightly lower than the actual rail pressure, to a leakage chamber 52 of the injector 1, which leakage chamber is preferably in permanent fluidic communication with an ambient pressure. The leakage chamber 52 is preferably in fluidic communication with a leakage port 504 of the injector 1. A relatively very high pressure difference prevails at the transmission pin 212, which pressure difference may by all means exceed a value of 2450 bar, for example in the case of an assumed maximum pressure of 2500 bar and when the injector 1 is closed.

The first control chamber 22 is preferably in permanent fluidic communication, by way of a connecting bore 14 in a section of the control assembly 20, with a second control chamber 12, the so-called needle control chamber 12. As in the first control chamber 22, a fuel pressure slightly lower than the rail pressure prevails in the second control chamber 12, wherein the pressures in the control chambers 12, 22 are substantially equal at least when the injector 1 is closed. A fluid throttle (not illustrated), which is preferably formed in a separate plate 230 of the control assembly 20, may be provided in the connecting bore 14.

A stroke (lengthening) of the piezo actuator 510 is transmitted by way of the transmission pin 214, which is also referred to as leakage pin 214, to a control piston 300 which is fitted in and/or paired with a control bore 400 of a control plate 220 of the control assembly 20. The transmission pin 212 engages, at/in the first control chamber 22, on an upper face surface of the control piston 300, wherein the control piston 300 is supported, on an internal face surface, by an energy store 224, which is preferably in the form of a spiral spring 224. It is preferable for substantially rail pressure to prevail at the internal face surface and at an underside of the control piston 300, wherein said region is preferably in permanent fluidic communication, through a connecting bore 232, with the nozzle chamber 102.

In the present examples, the control piston 300 is in the form of a sleeve 300 which is closed at the top side (side of the first control chamber 22) and into the interior 340 of which the spring element 224 for the restoring movement of the control piston 300 projects. It is self-evidently possible for the control piston 300 to be in the form of a solid cylinder, wherein then, the spring element 224 engages on a bottom side of the control piston 300, and the spring element 224 may be mounted for example in a bore in the plate 230. Mixed forms between the illustrated sleeve-shaped control piston 300 and a control piston 300 in the form of a solid cylinder are also self-evidently possible.

The second control chamber 12 is formed by a face surface of an upper longitudinal end section 112 of the nozzle needle 110, the so-called needle piston 112, by a wall of a needle bore 122 in an upper guide 120 of the nozzle needle 110, preferably in a nozzle needle sleeve 120, and by a lower face surface of the plate 230. The needle piston 112 of the nozzle needle 110 is in this case averted from a nozzle needle tip of the nozzle needle 110 or of the nozzle 104 of the nozzle body 100. This embodiment of the injector 1, presented here briefly, is not to be regarded as being restrictive. The invention is self-evidently applicable to a multiplicity of other embodiments of injectors.

As a result of a movement of the control piston 300 owing to a stroke of the piezo actuator 510 (via the transmission pin 214), a pressure drop is generated in the first control chamber 22, which pressure drop is transmitted via the connecting bore 14 and, possibly with a time delay, through the optional fluid throttle in the plate 230, to the upper face surface of the nozzle needle 110 in the second control chamber 12. If said pressure drop exceeds a particular value, the nozzle needle 110 opens, and an injection of fuel (shot) takes place. A stroke of the nozzle needle 110 can, proceeding from an opening of the nozzle needle 110, be controlled or regulated by way of a variation of the stroke of the piezo actuator 510. The stroke of the piezo actuator 510 may in this case be changed by way of a variation of the intrinsic electrical energy thereof.

During the discharging of the piezo actuator 510, the length of the latter decreases. By way of the rail pressure, acting on the internal face surface (bottom side) of the control piston 300, from the nozzle chamber 102 together with the force, likewise acting in said direction, of the spring element 224, the control piston 300 is pushed back into its initial position, which is determined by a position of the transmission pin 214. In this way, the nozzle needle 110 is, corresponding to the movement of the piezo actuator 510, moved into its closed position again, and an injection of fuel is ended. The nozzle needle spring 114 then holds the nozzle needle 110 securely closed on its seat in the nozzle 104 of the nozzle body 100.

It is an aim of the invention to ensure the least possible shot-to-shot variance of the injections. Here, it is necessary for the fluid pressure in the control chamber 12, 22 to be set as exactly as possible and reproducibly, in a manner dependent on the rail pressure, during an injection interval. This reproducible behavior may then be taken into consideration in the actuation of the piezo actuator 510. A fluid pressure that is set in the control chamber 12, 22 is influenced to a great extent by the control piston 300 (generally also: piston 300) and the control bore 400 (generally also: fluid line 400). Here, in addition to a fixed, tolerance-afflicted size of a sealing gap 222 between the control piston 300 and the control bore 400, a position of the control piston 300 in the control bore 400 is also of significance, because fluctuating positions of the control piston 300 in the control bore 400 lead to increased shot-to-shot variance.

Possible positions of the control piston 300 in the control bore 400 are substantially a concentric position, an eccentric position and a tilted position. By way of these different positions of the control piston 300, the flow resistances in the control bore 400 vary significantly owing to a gap geometry resulting from the respective position. The flow of fluid through the sealing gap 222 in the case of a maximally eccentric position of the control piston 300 is increased by a factor of approximately 2.5 in relation to the concentric position of said control piston. In the case of a maximally tilted position of the control piston 300, said factor is only approximately 0.5. That is to say, five times as much fluid can flow through the sealing gap 222 per unit of time in the case of a maximally eccentric position of the control piston 300 than in the case of a maximally tilted position (in an injector 1). This has significant effects on the pressures, set during the injection intervals, in the control chambers 12, 22, in particular in the first control chamber 22.

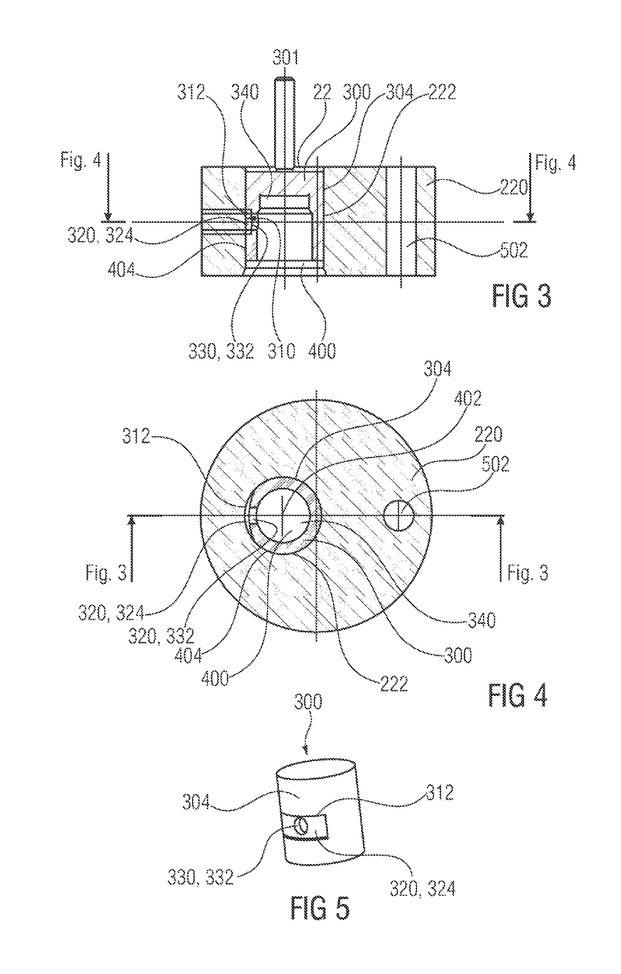

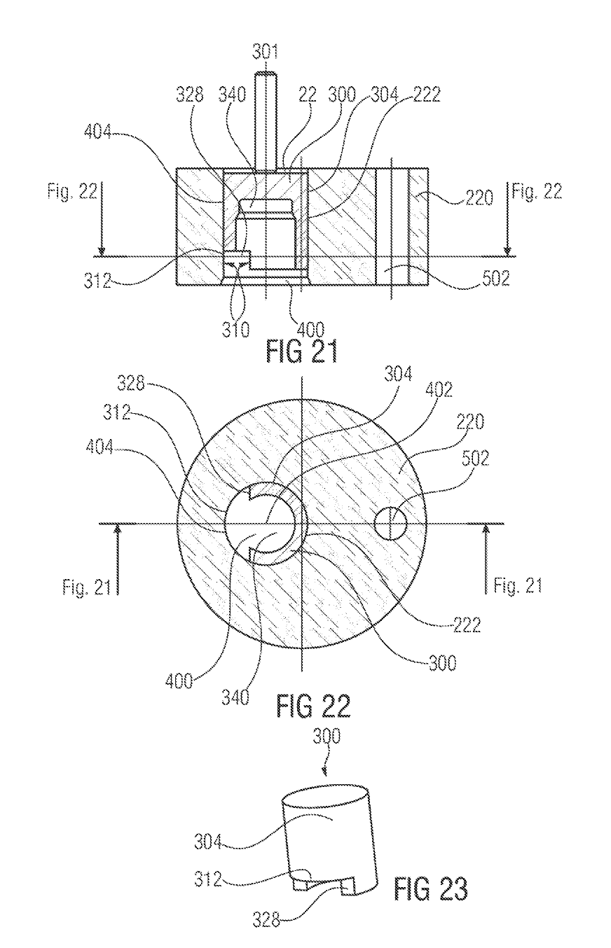

The solution according to the invention to this problem consists in the use of a geometry of the control piston 300 (cf. FIGS. 3 to 23) and/or a geometry of the control bore 400 (cf. FIGS. 24 and 25) to influence a position of the control piston 300 in the control bore 400. This is preferably performed in such a way that primarily a reliable eccentric and non-concentric and non-tilted position of the control piston 300 in the control bore 400 is sought. It is secondarily the case that, in said reliable eccentric position, a throughflow of the fluid (in this case fuel) through a sealing gap 222 that is set should be relatively small. The corresponding geometry or the corresponding geometries are in this case selected such that a centerline 302 of the control piston 300 is oriented parallel to a centerline 402 of the control bore 400, wherein the two centerlines 302, 402 are not aligned with one another but rather are spaced apart from one another, in particular are not maximally spaced apart from one another.

In some embodiments, the control piston 300 is modified at its shell face 304, and/or the control bore 400 is modified at its internal face 404, such that a resultant sideward force on the control piston 300 is generated, which ensures an eccentric preferential position of the control piston 300 in the control bore 400. This yields stochastic fluctuations of the injection quantities at a relatively low level even in the presence of high rail pressures. Such a modification is realized preferably by way of a fluid path 310, 410 on/in the control piston 300 and/or on/in the control bore 400, which fluid path opens at the control piston 300 (opening 312, 412).

Here, the fluid path 310, 410 may be a groove, for example a circumferential groove and/or a longitudinal groove, a facet, for example a circumferential facet and/or a longitudinal facet, a cutaway portion and/or a fluidic connection such as a bore, a passage bore and/or an intersection etc. or any desired combination of these. According to this specification, all of these expressions are intended to be subsumed under the expression “recess”, in the sense of deviations from a primary geometry of the control piston 300 and/or of the control bore 400. The primary geometry of the control bore 400 or of the control piston 300 is the shape of a (hollow) cylinder or of a (hollow) cone. The control piston 300 may in this case be a part or a section of another component, for example a needle piston 112 of a nozzle needle 110, a valve body or a part or section thereof etc. This applies analogously to the control bore 400, which need not imperatively be formed in the control plate 220.

An opening 312, 412 of the fluid path 310, 410, constructed from one recess or a multiplicity of recesses 320, 322; 422, 426, is in this case designed such that the centerlines 302, 402 of the control piston 300 and of the control bore 400 are spaced apart from and substantially parallel to one another. Here, it is particularly preferable for the sideward force exerted on the control piston 300 by the fluid passing through the opening 312, 412 (said sideward force resulting from the asymmetrical pressure distribution owing to the opening 312, 412) to engage on the control piston 300 substantially longitudinally in the center, such that substantially no tilting moment is exerted on the control piston 300. This may have the result that the opening 312, 412 itself is provided eccentrically on the control piston 300 (cf. FIG. 5), because the pressure conditions in the sealing gap 222 change from the high-pressure side to the low-pressure side, wherein the sealing gap 222 acts as a fluid throttle. According to the invention, the fluid path 310, 410 of the control piston 300 and/or of the control bore 400 may be in communication with the high-pressure side (FIGS. 3 to 24) or with the low-pressure side (FIG. 25). The fluidic communication of the fluid path 310, 410 with the low-pressure side is a hydraulic reversal of the fluidic communication of the fluid path 310, 410 with the high-pressure side. In the former case, a positive pressure at the opening 312, 412 on the control piston 300 serves to realize a parallel offset of the control piston 300 in relation to the control bore 400. In the second case, a negative pressure at the opening 312, 412 on the control piston 300 serves to realize a parallel offset of the control piston 300 in relation to the control bore 400.

Below, a general embodiment of the invention will firstly be discussed in more detail with reference to FIGS. 3 to 23. Subsequently, the—self-evidently not exhaustive—seven embodiments of the invention, pertaining to the control piston 300 or a piston 300, will be briefly discussed. These explanations are however analogously transferable to the control bore 400 or to a fluid line 400, depending on whether this appears expedient. In this regard, see FIGS. 24 and 25, which show two embodiments of the invention in which the concept according to the invention is applied to the control bore 400 or to the fluid line 400. In particular, FIG. 25 shows a fluid path 410 fluidically connected to the low-pressure side (first control chamber 22). This is intended to illustrate that any fluid paths 310 of the control piston 300 may also be hydraulically connected to the low-pressure side (cf. above).

A major design feature is that one recess or a multiplicity of recesses 320—fluid path 310 or a section thereof—in possibly different geometries are formed on/in the shell face 304 of the control piston 300 on one side. Said recesses 320 lead to the asymmetrical pressure distribution in the sealing gap 222, giving rise to the resultant sideward force which moves the control piston 300 into its eccentric preferential position. Since a piston interior 340 or a bottom side of the control piston 300 is acted on substantially with the rail pressure of the injector 1, a pressure substantially at the level of the rail pressure prevails in the fluid path 310.

On a side of the sealing gap 222 situated opposite the opening 312 of the fluid path 310 on the central piston 300, the fluid pressure falls, over an entire length of the sealing gap 222, from the rail pressure to the fluid pressure of the first control chamber 22. The varying pressure profile along the sealing gap 222 in the longitudinal direction of the control piston 300, between a side of the opening 312 of the fluid path 310 and a side averted therefrom, yields the abovementioned resultant sideward force on the control piston 300.

A width (circumferential direction of the control piston 300) and height (longitudinal direction of the control piston 300) and an axial position of the opening 312 determine the hydraulic sideward force on the control piston 300. An advantageous and possibly “optimum” design for the injector 1 provides a hydraulic sideward force which permanently reliably positions the control piston 300 eccentrically (the sideward force is in this case greater than a sum of possible “disturbance” forces, such as for example a transverse force arising from the spring element 224), wherein the hydraulic sideward force on the control piston 300 in this case is, or remains, preferably relatively small, in particular minimal.

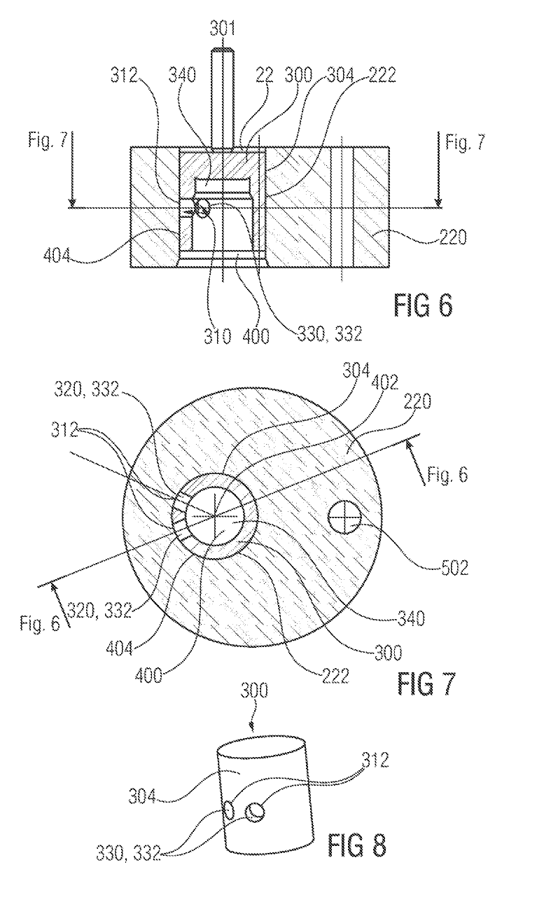

In the example embodiment of the invention as illustrated in FIGS. 3 to 5, as a recess 320, a groove 324 running in a circumferential and longitudinal direction of the control piston 300 is formed into the shell face 304 of the control piston 300 (external recess 320). The circumferential groove 324 is in fluidic communication, by way of a fluidic connection 330, in particular a passage bore 332, with the piston interior 340, which connects a base of the circumferential groove 324 to the piston interior 340 in a preferably radial direction. The base of the circumferential groove 324 may, as can be seen in FIG. 4, have a radius which is for example greater than that of the control piston 300. The base may self-evidently also be planar (cf. FIG. 13). A delimitation of the circumferential groove 324 at the shell face 304 forms the opening 312 of the fluid path 310. In the second embodiment of the invention, as illustrated in FIGS. 6 to 8, it is the case that, instead of the circumferential groove 324 in the first embodiment, two fluidic connections 330, in particular two passage bores 332, are formed in a wall of the control piston 300, preferably so as to run in a radial direction. Here, the passage bores 332 are situated on one side of the control piston 300, and an angle of the centerlines thereof is preferably less than 120°, in particular less than 90° and particularly preferably less than 45°. The delimitations of the passage bores 332 at the shell face 304 together form the opening 312 of the fluid path 310. It is self-evidently possible for only one passage bore or a multiplicity of passage bores to be provided through the wall of the control piston 300.

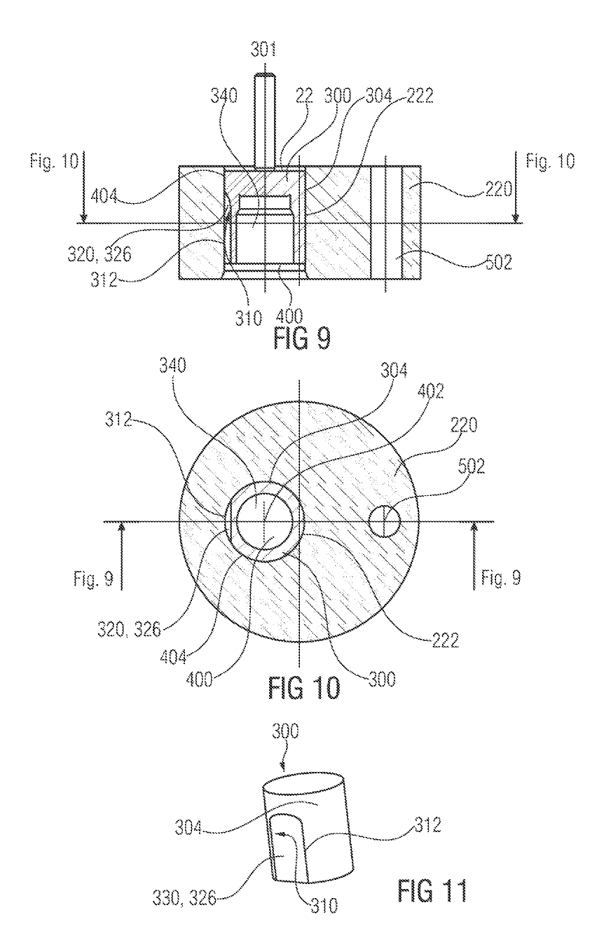

In the third embodiment of the invention as illustrated in FIGS. 9 to 11, the fluid path 310 comprises an external recess 320 which is in the form of a longitudinal facet 326 or longitudinal groove 326. Here, a surface 326 is ground or formed on the control piston 300 over a certain length and width (circumferential direction of the control piston 300), which surface is open toward the side of the rail pressure, or else for example toward the side of the first control chamber 22 (not illustrated, cf. FIG. 25). A base of the longitudinal facet 326 or longitudinal groove 326 may, as can be seen in FIG. 10, be planar, though a radius analogous to FIG. 4 may also be used. A delimitation of the longitudinal groove 326 or longitudinal facet 326 at the shell face 304 forms the opening 312 of the fluid path 310.

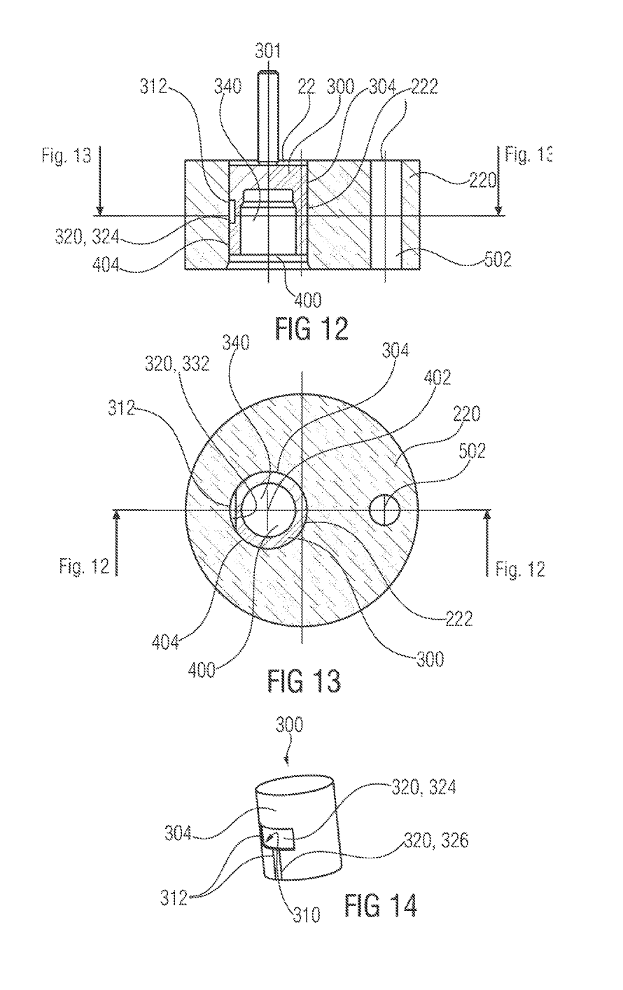

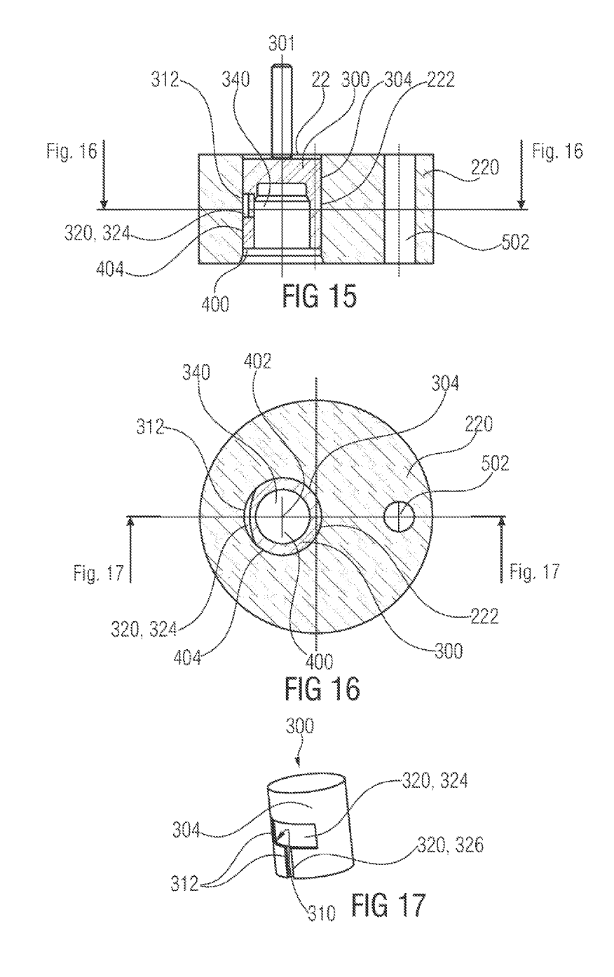

In the fourth embodiment of the invention illustrated in FIGS. 12 to 14, and in the fifth embodiment of the invention illustrated in FIGS. 15 to 17, the fluid path 310 comprises, in each case proceeding from the rail-pressure side of the control piston 300, a narrow external recess 320 which is formed as a longitudinal connecting groove 326 in the shell face 304 of the control piston 300. In the direction of the side of the first control chamber 22, the respective longitudinal connecting groove 326 opens into an external recess 320 which is formed in each case as a circumferential groove 324. A delimitation of the circumferential groove 324 and, to a small extent, a delimitation of the longitudinal connecting groove 326 at the shell face 304 together form the opening 312 of the fluid path 310.

The fourth embodiment is characterized in that a base of the circumferential groove 324 is planar (FIG. 13), whereas, in the case of the fifth embodiment, a base of the circumferential groove 324 has a radius (FIG. 16), which in turn may be greater than that of the control piston 300. Furthermore, the circumferential groove 324 of the fifth embodiment covers a larger region on the outside of the control piston 300 than the circumferential groove 324 of the fourth embodiment. In the first case, the circumferential groove 324 covers approximately 90°, and in the second case, the circumferential groove covers approximately 30-45°. Furthermore, the longitudinal connecting groove 326 may be formed into the wall of the control piston 300 with a smaller depth, equal depth or greater depth than the circumferential groove 324 in the region adjoining the latter.

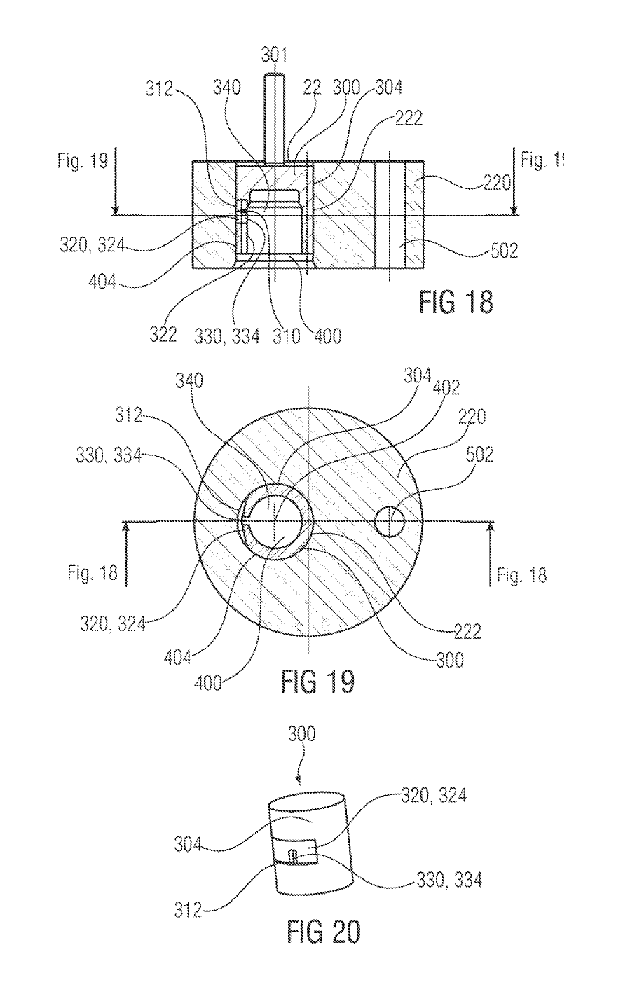

In the sixth embodiment of the invention as illustrated in FIGS. 18 to 20, the fluid path 310 comprises an external recess 320 which is in the form of a circumferential groove 324. A base of the circumferential groove 324 has, in turn, a radius (see above), though may also be of planar form. The base of the circumferential groove 324 is fluidically connected to the piston interior 340 via an intersection 334 formed as a fluidic connection 330. The intersection 334 is produced by way of a longitudinal groove 322, in the form of an internal recess 322, in the piston interior 340. That is to say, the fluidic connection 330 of the circumferential groove 324 to the side of the rail pressure is produced by way of the intersection 324 with the longitudinal groove 322 in the longitudinal direction of the control piston 300 on an inner side of the control piston 300. A delimitation of the circumferential groove 324 on the shell face 304 forms the opening 312 of the fluid path 310.

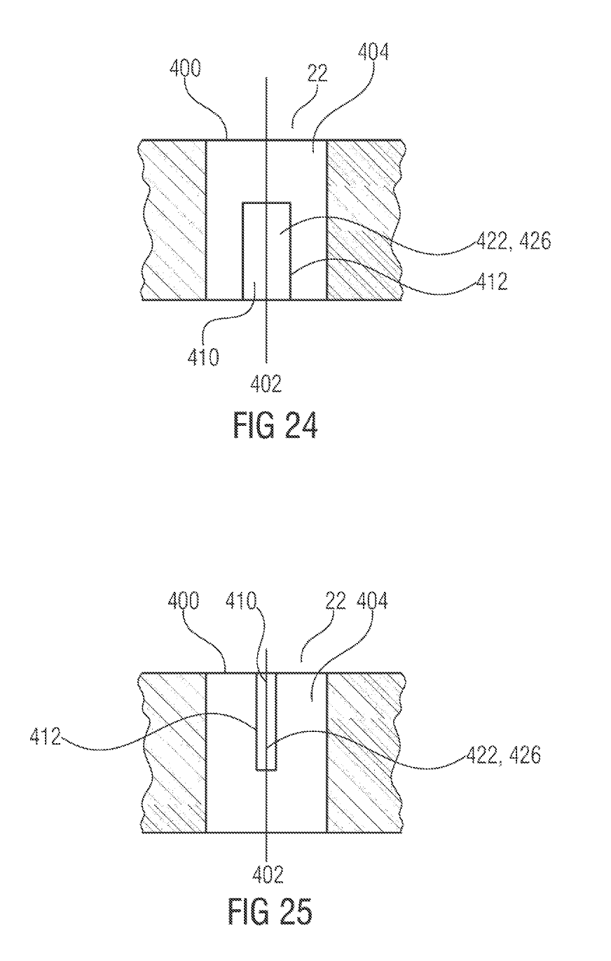

In the seventh embodiment of the invention as illustrated in FIGS. 21 to 23, the fluid path 310 comprises a recess 328 or a cutaway portion 328 of a wall of the control piston 300, that is to say a piston skirt of the control piston 300 is shortened on one side over a certain circular segment. A delimitation of the cutaway portion 328 at the shell face 304 in this case forms the opening 312 of the fluid path 310.

These exemplary embodiments of the invention may self-evidently also be applied to control pistons 300 which are not of hollow-bored form. In such a situation, it may be necessary for a preferably small bore to be formed into the control piston 300. Furthermore, said features may also be applied to other fit and/or pairing clearances in the injector 1, for example to the transmission pin 214 in the pin bore 212, to the nozzle needle 110 in the nozzle needle sleeve 120, etc., which in particular influence a leakage balance (inflowing equal to outflowing) and thus also a resultant pressure in the control chamber 12, 22. Furthermore, the invention is generally applicable to hydraulic coupling elements 300, that is to say the control piston 300 is in the form of a hydraulic coupling element 300.

Below, two exemplary embodiments of the invention will be briefly discussed, wherein the respective recess 422 is provided not on/in the control piston 300 but on/in the internal face 404 of the control bore 400 (fluid line 400).

In the eighth embodiment of the invention as illustrated in FIG. 24, the fluid path 410 of the control bore 400 comprises an internal recess 422 which is in the form of a longitudinal facet 426 or longitudinal groove 426. Here, a surface 426 or recess 426 is ground or formed into the internal face 404 of the control bore 400 over a certain length and width (circumferential direction of the control bore 400), which surface or recess is open toward the side of the rail pressure. Said surface or recess may however also be open toward the side of the first control chamber 22 (not illustrated, cf. FIG. 25). A base of the longitudinal facet 426 or longitudinal groove 426 may, as can be seen in FIG. 10, be planar, though a radius analogous to FIG. 4 may also be used, wherein the radius is preferably smaller than that of the control bore 400. A delimitation of the longitudinal facet 426 or longitudinal groove 426 at the internal face 404 forms the opening 412 of the fluid path 410 of the control bore 400 on the control piston 300.

In the ninth embodiment of the invention as illustrated in FIG. 25, the fluid path 410 of the control bore 400 comprises an internal recess 422 which is in the form of a narrow longitudinal groove 426 and which is open toward the side of the first control chamber 22. A delimitation of the longitudinal groove 426 at the internal face 404 substantially forms the opening 412 of the fluid path 410 of the control bore 400 on the control piston 300. During operation of the injector 1, substantially a fluid pressure of the low-pressure side or of the first control chamber 22 prevails in the longitudinal groove 426. Here, the internal recess 422 is such, in particular is formed so as to run in the longitudinal direction of the control bore 400 in such a way, that an asymmetrical pressure distribution of the fluid on the control piston 300 is realized, wherein the control piston 300 is pulled by suction in the direction of the opening 412 of the fluid path 410, or is pushed from a side situated opposite this by the fluid pressure in the sealing gap 222.

Such hydraulically reversed embodiments of the invention are generally applicable. Here, the pressure conditions at the control piston 300 in a radial direction of the control piston 300 are at least qualitatively reversed. That is to say, a pressure side and a suction side at the control piston 300 change their positions. For embodiments one to seven of the invention, this means that the fluid path 310 of the control piston 300 is open toward the low-pressure side, and opens out in the sealing gap 222 on the control piston. A fluidic connection to the piston interior 340 must in this case self-evidently be prevented.

A simple embodiment of the invention which is not illustrated is a pressure duct through a control piston 300 in the form of a solid cylinder. Here, it is for example the case that two intersecting blind bores are formed in the control piston 300. One bore extends axially from the low-pressure side into the control piston 300, and the other extends radially to said first bore and intersects the latter within the control piston 300. Then, in the injector 1, a pressure duct exists from the low-pressure side on one side into/to the sealing gap 222 between the control piston 300 and the control bore 400. Said embodiment may self-evidently be hydraulically reversed, wherein the first blind bore is formed in the control piston 300 so as to extend not from the low-pressure side but from the high-pressure side. In the case of a fully rotationally symmetrical control piston 300, this may be simply reversed in order to move from this embodiment to the other embodiment.

### LIST OF REFERENCE NUMERALS

1 Injector, fuel injector, common-rail/piezo fuel injector, pump-nozzle fuel injector, diesel injector, gasoline injector
10 Nozzle assembly, injection module
12 Second control chamber, needle control chamber
14 Connecting bore/line between first 22 and second control chamber 12
20 Control assembly of the nozzle assembly 10 for the control of the nozzle needle 110
22 First control chamber, piston control chamber
50 Injector assembly, drive module
52 Leakage chamber
60 Nozzle clamping nut, valve clamping nut
100 Nozzle body
102 Nozzle chamber, nozzle bore
104 Nozzle, injection nozzle, valve
110 Nozzle needle, injection needle, possibly in two or multiple parts, inwardly or outwardly opening
112 Upper longitudinal end section of the nozzle needle 110, needle piston, averted from the nozzle 104 and/or from a valve of the injector 1
114 Energy store, spring element, spiral spring, compression spring, nozzle needle spring, injection needle spring, for mechanical preloading of the nozzle needle 110
120 (upper) guide of the nozzle needle 110, nozzle needle sleeve
122 Needle bore
210 Intermediate plate
212 Pin bore
214 Transmission pin, leakage pin
220 Control plate
222 Sealing gap between piston 300 and fluid line 400
224 Energy store, spring element, spiral spring, compression spring, for preloading of the piston 300
230 Plate
232 Connecting bore
300 Piston, control piston, hydraulic coupling element
302 Centerline of the piston 300304 Shell face, shell surface, shell side of the piston 300
310 Fluid path on/in the piston 300
312 Opening of the fluid path 310 on the piston 300
320 (External) recess, external recess
322 (Internal) recess, internal recess
324 Groove, facet, circumferential groove, circumferential facet, recess
326 Groove, facet, longitudinal groove, longitudinal facet, recess
328 Cutaway portion, recess
330 Fluidic connection between the interior and exterior of the piston 300, recess
332 Bore, passage bore, fluidic connection, recess
334 Intersection, fluidic connection, recess
340 Piston interior, interior
400 Fluid line, control bore, piston bore
402 Centerline of the fluid line 400
404 Internal face, internal surface, inner side of the fluid line 400
410 Fluid path on the fluid line 400 or on/in internal face 404
412 Opening of the fluid path 310 on the piston 300
422 (Internal) recess, internal recess
426 Groove, facet, longitudinal groove, longitudinal facet, recess
500 Injector body, injector housing with high-pressure line
502 to nozzle chamber 102
502 High-pressure line/bore fluidically connected to nozzle chamber 102 through the control assembly 20
504 Leakage port
510 Actuator, piezo actuator, electromagnetic actuator
512 Base plate of the actuator 510, preferably with actuation projection for transmission pin 214

What is claimed is:

1. A fuel injector comprising:
a piston; and
a fluid line;
wherein
a geometry of the piston and/or a geometry of the fluid line are/is configured such that the piston is positioned eccentrically in the fluid line by the fluid.

2. The fuel injector as claimed in claim 1, wherein
a centerline of the piston is positioned substantially parallel to a centerline of the fluid line by the fluid.

3. The fuel injector as claimed in claim 1, wherein
a throughflow of the fluid between the piston and the fluid line is greater than a throughflow in the case of a concentric position of the piston in the fluid line.

4. The fuel injector as claimed in claim 1, wherein:
an asymmetrical pressure distribution of the fluid is set in a sealing gap between a shell face of the piston and an internal face of the fluid line.

5. The fuel injector as claimed in claim 1, wherein
in the shell face of the piston and/or the internal face of the fluid line, there is a fluid path by way of which the asymmetrical pressure distribution of the fluid in the sealing gap is set.

6. The fuel injector as claimed in claim 1, wherein
in the shell face of the piston and/or the internal face of the fluid line, the fluid path is provided such that a sideward force can be exerted, and is exerted, on the piston by way of the fluid.

7. The fuel injector as claimed in claim 1, wherein the fluid path is formed such that the piston is securely positioned in an eccentric position and the throughflow of the fluid through the sealing gap is relatively low.

8. The fuel injector as claimed in claim 1, wherein:
the fluid path on/in the piston is in fluidic communication with a high-pressure side or with a low-pressure side of the piston; and
the fluid in the fluid path pushes the piston away from an opening of the fluid path on/in the piston, and/or the fluid in the sealing gap pushes the piston toward an opening of the fluid path on/in the piston.

9. The fuel injector as claimed in claim 1, wherein the fluid path has a recess on/in the piston,
the recess on/in the piston is a groove or facet which runs in a circumferential direction and/or longitudinal direction of the piston.

10. The fuel injector as claimed claim 1, wherein the fluid path provides a fluidic connection between an interior and an exterior of the piston and
the fluidic connection comprises a bore.

11. The fuel injector as claimed in claim 1, wherein the fluid path comprises:
the opening on the outside of the piston;
a circumferential groove and/or a circumferential facet on the outside of the piston;
a longitudinal groove and/or a longitudinal facet on the outside of the piston;
at least one bore from an outer side of the piston to a piston interior;
an intersection of an external recess with an internal recess; or
a cutaway portion on a longitudinal end section of the piston.

12. The fuel injector as claimed in claim 1, wherein the fluid path is set up analogously to the piston in the fluid line.

13. The piston-fluid line arrangement as claimed in claim 1, wherein:
the piston comprises a control piston, a pin, and a control pin;
a base of the recess is planar or curved;
a primary geometry of the piston is a cylindrical shape; and
a primary geometry of the fluid line is a cylindrical shape.

14. The fuel injector as claimed in claim 1, wherein
the piston is in the form of a hydraulic coupling element.
